(19) United States
(12) Patent Application Publication
(10) Pub. No.: US 2010/0305013 A1
(43) Pub. Date: Dec. 2, 2010

(54) Bleach Delivery System and Method

(75) Inventor: Paul H. Hanifl, Barrington Hills, IL (US)

Correspondence Address: BARNES & THORNBURG LLP, P.O. BOX 2786, CHICAGO, IL, 60690-2786, US

(73) Assignee: SAGE PRODUCTS, INC., Cary, IL (US)

(21) Appl. No.: 12/473,495

(22) Filed: May 28, 2009

(51) Int. Cl. C11D 17/06

(52) U.S. Cl. 510/133

(57) ABSTRACT

A method and system for providing a disinfecting washcloth impregnable with bleach and having a pH under 7.0. Liquid bleach having a pH over 7.0 is provided in a frangible pouch, and is located with at least one absorbent washcloth in an outer package. A buffer of sufficient quantity and concentration when combined with the bleach is also provided, either already impregnating the washcloth or in a separate frangible pouch. The frangible pouches may also be located in yet another mixing pouch for mixing the liquid bleach and buffer before the absorbent washcloth is impregnated.

### BACKGROUND OF THE INVENTION

This invention relates to disinfection, and in particular to a method and system for providing a disinfecting washcloth impregnable with bleach and having a pH under 7.0.

Closteridium difficile, also known as “C. diff”, is a species of Gram-positive bacteria of the Genus Closteridium. Clostridia are anaerobic spores which are becoming more prevalent in many healthcare locations, such as hospitals and nursing homes. C. diff is the most serious cause of antibiotic-associated diarrhea (AAD) with the bacteria causing bloating, constipation and diarrhea with abdominal pain, often severe. Symptoms are often flu like in nature, and relapses are common.

With the introduction of broad spectrum antibiotics in the twentieth century, AAD has become more common. Infection with C. diff can range in severity to severe and life-threatening, particularly among the weak and elderly. While C. diff infection is typically in hospitals, nursing homes or similar institutions, infection elsewhere in the broader community is increasing. It has been said that the rate of C. diff acquisition is estimated at fifty percent in those with hospital stays longer than four weeks. Thus, aggressive intervention and prevention are key to limiting the spread.

Several disinfectants commonly used in hospitals are largely ineffective against C. diff spores, and it is believed that some may actually promote spore formation. However, disinfectants containing bleach are effective in killing C. diff. Common bleach, which is effective against C. diff, is often called “chlorine bleach”, which contains a solution of approximately 3-6% sodium hypochlorite (NaClO). As used in this application, “bleach” or “liquid bleach” is the common household or chlorine bleach employing sodium hypochlorite.

Normal bleach disinfecting solutions used in a hospital setting is mixed ten to one to obtain a concentration of 5,000 ppm bleach. It has a pH of about 11. However, a solution of that elevated a pH is not tolerated by the skin, and has more limited ability to kill C. diff spores. To obtain a bleach solution that is kind to skin and effective against C. diff spores, the concentration must be below 500 ppm with a pH below 7.

The problem of compounding a bleach solution with a pH below 7 is aging. The effectiveness of bleach with a pH below 7 dissipates quickly. Thus, the bleach must be maintained with a high pH until just before use, when the pH is then reduced.

Buffer solutions are used as a means of keeping pH at a nearly constant value, or reducing pH and then maintaining it at a reduced value. As used in this application, a buffer is typically an aqueous solution which can reduce the pH of bleach to the usable level described herein, below 7.0.

### SUMMARY OF THE INVENTION

The invention is directed to a method and system for providing a disinfecting washcloth impregnable with bleach and having a pH under 7.0. In accordance with one form of the method of the invention, the method comprises the steps of providing liquid bleach having a pH over 7.0 in a frangible pouch, providing an absorbent washcloth impregnated with a buffer, with the buffer being of sufficient quantity and concentration, when combined with the liquid bleach, to reduce the pH of the liquid bleach below 7.0, and sealing the absorbent washcloth and the frangible pouch together in an outer package. The method further comprises the step of fracturing the frangible pouch in the outer package to release the liquid bleach to the absorbent washcloth to permeate the washcloth, permitting the buffer to reduce the pH.

In accordance with a second form of the method according to the invention, liquid bleach having a pH over 7.0 is provided in a frangible pouch, and a buffer is provided in a second frangible pouch, with the buffer being sufficient, when combined with the liquid bleach, to reduce the pH of the liquid bleach below 7.0. The frangible pouches, along with at least one absorbent washcloth, are sealed together in an outer package. In accordance with one form of this method, the frangible pouches are sealed in a mixing pouch before being located in the outer package. For preparation of the washcloth, the frangible pouches are fractured in the mixing pouch to release the liquid bleach and buffer together. The mixing pouch, while in the outer package, then releases the mixed liquid bleach and buffer to the absorbent washcloth. In accordance with a second version of this form of the method, the frangible pouches are oriented in fluid communication with the mixing pouch. Then, for preparation of the washcloth, the frangible pouches are fractured to release the liquid bleach and the buffer into the mixing pouch, and thereafter the contents of the mixing pouch in the outer package pass from the mixing pouch to release the mixed liquid bleach and the buffer to the absorbent washcloth.

In accordance with one form of the system according to the invention, an outer, sealed package is provided, having at least one absorbent washcloth therein, with the washcloth including a buffer which, when combined with liquid bleach, reduces the pH of the liquid bleach. A frangible pouch is disposed within the sealed package, with the frangible pouch containing liquid bleach of a pH over 7.0. The buffer in the washcloth is of a quantity and concentration, when combined with the liquid bleach, to reduce the pH of the liquid bleach to below 7.0.

The frangible pouch includes means for opening the pouch when sealed within the package in order to release the liquid bleach to impregnate the washcloth. Preferably, the buffer in the washcloth comprises at least one of monobasic sodium phosphate and dibasic sodium phosphate.

In another form of the system according to the invention, at least one absorbent washcloth is located in an outer, sealed package. A first frangible pouch is disposed within the sealed package, with the pouch containing the buffer, and a second frangible pouch is disposed within the sealed package, with the second frangible pouch containing liquid bleach of a pH over 7.0. The frangible pouches are either located in a mixing pouch disposed within the sealed package, or are positioned in fluid communication with the mixing pouch.

### BRIEF DESCRIPTION OF THE DRAWINGS

The invention is described in greater detail in the following description of examples embodying the best mode of the invention, taken in conjunction with the drawing figures, in which:

FIG. 1 is a schematic view of one form of a bleach delivery system according to the invention,

FIG. 2 is a schematic view of a second form of a bleach delivery system according to the invention, and

FIG. 3 is a schematic illustration of a second form of bleach and buffer mixing pouch according to the invention.

### DESCRIPTION OF EXAMPLES EMBODYING THE BEST MODE OF THE INVENTION

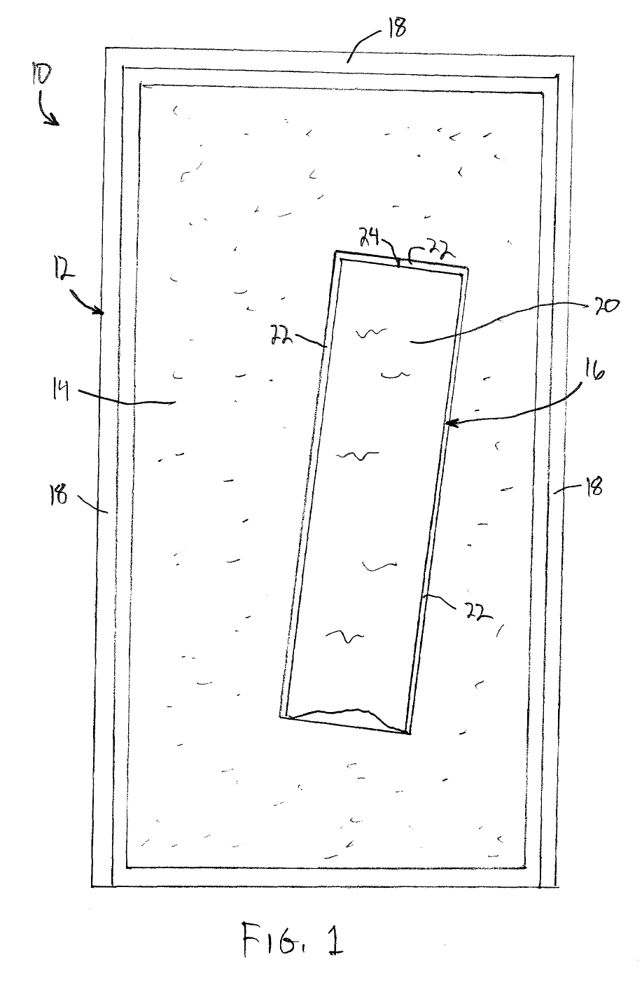

A system according to the invention is shown generally at 10 in FIG. 1. The system 10 is composed of three basic parts, an outer package 12, one or more absorbent washcloths 14, and a burst pouch or package 16.

The outer package 12 may be conventional, and can be formed of two sheets of plastic, such as polyethylene, or a single sheet of plastic which is folded on itself with the edges being heat sealed together at a heat seal 1 8 about the periphery of the package 12. Thus, the absorbent washcloth 14 and the burst pouch 16 are normally wholly sealed within the package 12 during shipping and storage, and thus may be sterile.

The washcloths 14 can be any absorbent material which can perform in the manner described herein to not only absorb liquid bleach and a buffer, but also release the solution to the skin when the washcloth 14 is used. An appropriate form of washcloth is disclosed in U.S. Pat. No. 5,956,794 to Skiba et al. which is owned by the assignee of the present invention. The washcloth comprises a blended cloth consisting of first fibers of rayon and second fibers of polyester. The fibers are blended by mechanical entanglement into a dense blend which has a substantial absorbency. Another form of washcloth is similar, but comprising fibers only of polyester. The washcloths 14 are described in greater detail in U.S. Pat. No. 5,956,794, the disclosure of which is incorporated herein by reference.

In the form of the invention shown in FIG. 1, the washcloth 14 is impregnated with a buffer. The buffer is of sufficient quantity and concentration, when combined with liquid bleach, to reduce the pH of the liquid bleach to below 7.0. Many buffers are available for that purpose, and in accordance with one form of the present invention, the buffer comprises at least one of monobasic sodium phosphate and dibasic sodium phosphate. Preferably, the buffer comprises a combination of both monobasic sodium phosphate and dibasic sodium phosphate.

The burst pouch 16 is a frangible pouch, and is filled with liquid bleach 20 having a pH over 7.0. Similar to the package 12, the burst pouch 16 may be formed of plastic, such as polyethylene, with a peripheral heat seal 22 to seal the liquid bleach 20 within the pouch 16. While preferably the burst pouch 16, and all other similar pouches described herein, is a burst pouch or package, it may also be any type of container which retains its liquid until it is desired that the liquid be released for mixing or saturation of a washcloth.

The illustrated burst pouch or package 16 is formed to be burst in a conventional fashion. For example, the pouch 16 can be filled with the liquid bleach 20 and an excess of air so that the pouch 16 may be burst by applying pressure to the pouch, compressing the air therewithin until either the structure of the pouch 16 ruptures, or one of the heat seals 22 fractures. Alternatively, the pouch 16 may be provided with a weakened area or perforation 24, which fractures when pressure is applied to the pouch 16. In yet another form, the pouch 16 can include any structure surrounding it having means to pierce the plastic of the pouch 16 to release the liquid bleach 20 to the washcloth 14. The particular manner of how the burst pouch 16 is frangible forms no part of the invention, and any conventional means can be used.

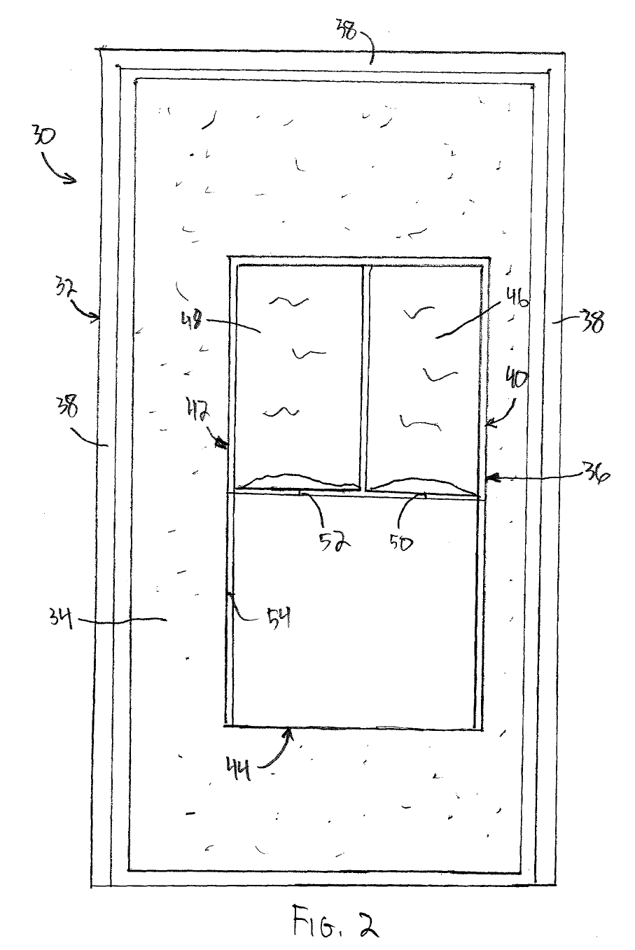

A second form of the system according to the invention is shown generally at 30 in FIG. 2. This form of the invention includes an outer package 32, one or more absorbent washcloths 34, and a multiple component pouch 36.

The outer package 32 is identical to the outer package 12, including a peripheral heat seal 38. The absorbent washcloths 34 are identical to the absorbent washcloths 14 of the first form of the invention above, but are not impregnated with a buffer.

The multiple component pouch 36 comprises three components, a first frangible pouch 40, a second frangible pouch 42 and a mixing pouch 44. One of the pouches 40 and 42 contains the liquid bleach, and the other contains the buffer. Purely for purposes of illustration, the first frangible pouch 40 includes a liquid bleach 46, and the second frangible pouch 42 includes a liquid buffer 48. To allow mixing in the mixing pouch 44, the pouch 40 includes a perforation 50, and the pouch 42 includes a perforation 52. However, just as with the burst pouch 16, the pouches 40 and 42 can be appropriately formed with other means of allowing expelling of their contents into the mixing pouch 44, as is well known to one skilled in the art.

The mixing pouch 44 is where the liquid bleach and buffer are mixed, before being expelled to the absorbent washcloths 34. The mixing pouch 44 may be of several forms, one shown in FIG. 2 where the pouch 44 is also frangible, one means being by a perforation or area of weakening 54. Other means of allowing the contents of the pouch 44 to be expelled into the outer package 32 can be used, as well known to those skilled in the art, and therefore are not described in greater detail. Also, as used herein, the term “mixing pouch” may be any pouch or package, sealed or not, which allows mixing, and can even be a sleeve.

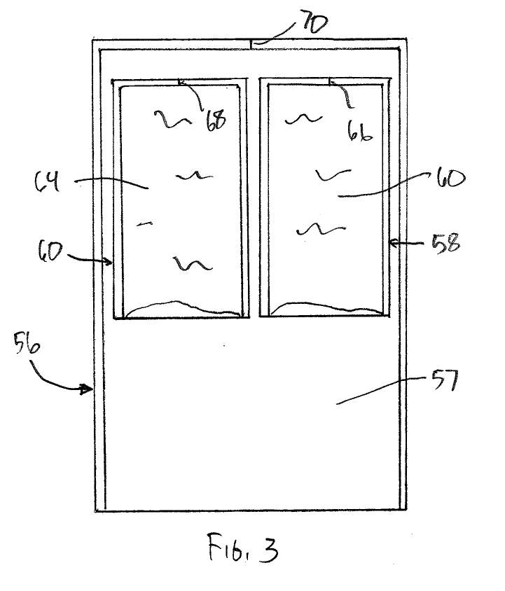

FIG. 3 illustrates an alternative form of the multiple burst pouch 36 of FIG. 2. In this form of the invention, a multiple component pouch 56 includes a mixing pouch 57 which has contained therewithin first and second frangible pouches 58 and 60. In a similar fashion to the pouch 36, one of the pouches 58 and 60 includes the liquid bleach, and the other includes the buffer. Purely for purposes of illustration, the first frangible pouch 58 includes the liquid bleach 62, and the second frangible pouch 60 includes the buffer 64. The pouch 58 includes a perforation or area of weakening 66, and the pouch 60 includes a perforation or area of weakening 68. Once the pouches 56 and 60 are fractured to allow their contents into the mixing pouch 57, those contents are mixed and can then be expelled from the mixing pouch 57 through a similar perforation or area of weakening 70, if the mixing pouch 57 is sealed.

In all forms of the invention, the pouches may be formed in a conventional fashion, using, for example, heat sealing or adhesives to seal the packages until their opening is desired. The various pouches can be formed in any manner so as to not only retain their contents, but also allow mixing and saturation of the washcloths as needed.

As explained above, bleach normally has a high pH. Even in a normal hospital setting, where the bleach is diluted ten to one to get a concentration of approximately 5,000 ppm, bleach still has a pH of about 11. That is still a substantial irritant to the skin, and typically the concentration must be below 500 ppm with a pH below 7 in order to be acceptable for use on the skin and to have desired efficacy against spores. Since the effectiveness of bleach dissipates quickly when the pH is below 7, separating the bleach from the buffer until the washcloths are to be used will allow effectiveness of the buffered bleach for a sufficient time.

In one form of the invention, mixing of the bleach and the buffer results in a concentration of bleach at one hundred parts per million at a pH of 6.75. This solution is effective for about ten to twenty minutes before the efficacy of the bleach dissipates, and spores cannot be effectively killed.

The invention provides a simple, convenient and easy-to-use means of providing a wide antibacterial spectrum that is particularly effective on C. diff. Various changes may be made to the invention without departing from the spirit thereof or scope of the following claims.

What is claimed is:

1. A method of providing a disinfecting washcloth impregnable with bleach and having a pH under 7.0, comprising the steps of:
a. providing liquid bleach having a pH over 7.0 in a frangible pouch,
b. providing an absorbent washcloth impregnated with a buffer, said buffer being of sufficient quantity and concentration, when combined with said liquid bleach, to reduce the pH of said liquid bleach below 7.0, and
c. sealing said absorbent washcloth and said frangible pouch together in an outer package.

2. The method according to claim 1, comprising the further step, after step c, of
d. fracturing said frangible pouch in said outer package to release said liquid bleach to said absorbent washcloth.

3. The method according to claim 2, comprising the further step, after step d, of
e. opening said outer package, and removing said absorbent washcloth for use.

4. A method of providing a disinfecting washcloth impregnable with bleach and having a pH under 7.0, comprising the steps of:
a. providing liquid bleach having a pH over 7.0 in a frangible pouch,
b. providing a buffer in a frangible pouch, said buffer being sufficient, when combined with said liquid bleach, to reduce the pH of said liquid bleach below 7.0,
c. providing at least one absorbent washcloth, and
d. sealing said absorbent washcloth and said frangible pouches together in an outer package.

5. The method according to claim 4, including the further step, before step d, of sealing said pouches in a mixing pouch.

6. The method according to claim 5, comprising the further steps, after step d, of
e. fracturing said frangible pouches in said mixing pouch to release said liquid bleach and buffer together, and
f. releasing said liquid bleach and buffer from said mixing pouch to said absorbent washcloth.

7. The method according to claim 4, including the further step, before step d, of orienting said pouches in communication with a mixing pouch.

8. The method according to claim 7, comprising the further steps, after step d, of
e. fracturing said frangible pouches to release said liquid bleach and said buffer into said mixing pouch, and
f. releasing said liquid bleach and buffer from said mixing pouch to said absorbent washcloth.

9. A system for providing a disinfecting washcloth impregnated with bleach having a pH under 7.0, comprising:
a. an outer, sealed package having at least one absorbent washcloth therein, said washcloth including a buffer which, when combined with liquid bleach, reduces the pH of the liquid bleach, and
b. a frangible pouch disposed within said sealed package, said frangible pouch containing liquid bleach of a pH over 7.0.

10. The system according to claim 9, in which said buffer is of a quantity and concentration, when combined with said liquid bleach, to reduce the pH of said liquid bleach to below 7.0

11. The system according to claim 9, in which said pouch includes means for opening said pouch when sealed within said package for releasing said liquid bleach to impregnate said washcloth with said liquid bleach.

12. The system according to claim 9, in which said buffer comprises at least one of monobasic sodium phosphate and dibasic sodium phosphate.

13. A system for providing a disinfecting washcloth impregnated with bleach having a pH under 7.0, comprising:
a. an outer, sealed package having at least one absorbent washcloth therein,
b. a first frangible pouch disposed within said sealed package, said pouch containing a buffer, and
c. a second frangible pouch disposed within said sealed package, said second frangible pouch containing liquid bleach of a pH over 7.0.

14. The system according to claim 13, in which said frangible pouches are located in a mixing pouch disposed within said sealed package.

15. The system according to claim 14, in which said frangible pouches include means for opening said frangible pouches when sealed within said mixing pouch.

16. The system according to claim 13, in which said pouches are in fluid communication with a mixing pouch disposed within said sealed package.

17. The system according to claim 16, in which said frangible pouches include means for releasing said liquid bleach and said buffer into said mixing pouch.

18. The system according to claim 13, in which said buffer is of a quantity and concentration, when combined with said liquid bleach, to reduce the pH of said liquid bleach to below 7.0

19. The system according to claim 13, in which said buffer comprises at least one of monobasic sodium phosphate and dibasic sodium phosphate.
